(19) United States
(12) Patent Application Publication
(10) Pub. No.: US 2006/0044302 A1
(43) Pub. Date: Mar. 2, 2006

(54) Notebook DC power sharing arrangement

(76) Inventor: Wilson Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/924,800

(22) Filed: Aug. 25, 2004

(51) Int. Cl. G09G 5/00

(52) U.S. Cl. 345/211

(57) ABSTRACT

A notebook DC power sharing arrangement is disclosed to include an adapter, which has an electric socket for DC input from an external DC power supply device and an electric plug power output to a notebook computer, a DC power converter connected to the adapter through a cable for converting input DC power to a predetermined voltage level, and a power cable extended from the DC power converter for power output to an external peripheral apparatus.

### BACKGROUND OF THE INVENTION

1. Field of the Invention

The present invention relates to power supply arrangement for notebook computer and peripheral apparatus and more particularly, to a notebook computer DC power sharing arrangement, which enables a notebook computer and a number of peripheral apparatus (Hard Disk Drive, CD-ROM Player, DVD-ROM Player, Digital Camera, Hub, etc.) to share power supply of a common external DC power supply device.

2. Description of the Related Art

FIG. 1 is a schematic drawing showing power and signal connection between a notebook computer 10′ and a peripheral apparatus 14′ according to the prior art. As illustrated, the electric plug 17′ of a first DC adapter 12′ is connected to the notebook computer 10′ to provide the notebook computer 10′ with the necessary working voltage; a second DC adapter 13′ is connected to the peripheral apparatus 14′ to provide the peripheral apparatus 14′ with the necessary working voltage; an electric signal connector 15′ is connected to the peripheral apparatus 14′ through a bus line 18′, having a signal port (USB port or IEEE1394 port) 19′ connectable to an I/O port 11′ of the notebook computer 10′ through a signal line 16′. This arrangement has drawbacks as follows:
1. When carrying the notebook computer 10′ and peripheral apparatus 14′ outdoors, extra delivery space is required for the first DC adapter 12′ and the second DC adapter 13′.

2. When only one electric outlet is available, the user cannot obtain the necessary working voltage for the peripheral apparatus 14′ after connection of the first DC adapter 12′ to the electric outlet.

3. The first DC adapter 12′ and the second DC adapter 13′ may hinder each other if the user try to connect the two DC adapters 12′ and 13′ to two adjacent electric sockets of an electric outlet assembly.

### SUMMARY OF THE INVENTION

The present invention has been accomplished under the circumstances in view. It is one object of the present invention to provide a notebook DC power sharing arrangement, which enables a notebook computer and a number of peripheral apparatus to share power supply of a common external DC power supply device. It is another object of the present invention to provide a notebook DC power sharing arrangement, which is inexpensive to manufacture. To achieve these and other objects of the present invention, the notebook DC power sharing arrangement comprises an adapter, the adapter having an electric socket at a first end thereof for DC input from an external DC power supply device and an electric plug at a second end thereof for connection to the power jack of a notebook computer for transmitting DC power supply from the electric socket into the notebook computer; a DC power converter adapted to convert DC power obtained from the electric socket of the adapter into a predetermined voltage level; a cable connected between the adapter and the DC power converter for transmission of DC power from the electric socket of the adapter to the DC power converter; and at least one power cable extended from the DC power converter for power output.

### BRIEF DESCRIPTION OF THE DRAWINGS

FIG. 1 is a schematic drawing showing connection between a notebook computer and a peripheral apparatus according to the prior art.

FIG. 2 is a schematic drawing showing a notebook DC power sharing arrangement according to the present invention.

FIG. 3 is a schematic drawing showing an alternate form of the DC power sharing arrangement according to the present invention.

FIG. 4 is a schematic drawing showing an application example of the present invention.

FIG. 5 is a schematic drawing showing another alternate form of the DC power sharing arrangement according to the present invention.

FIG. 6 is a schematic drawing showing still another alternate form of the DC power sharing arrangement according to the present invention.

FIG. 7 is a schematic drawing showing an application example of the embodiment shown in FIG. 6.

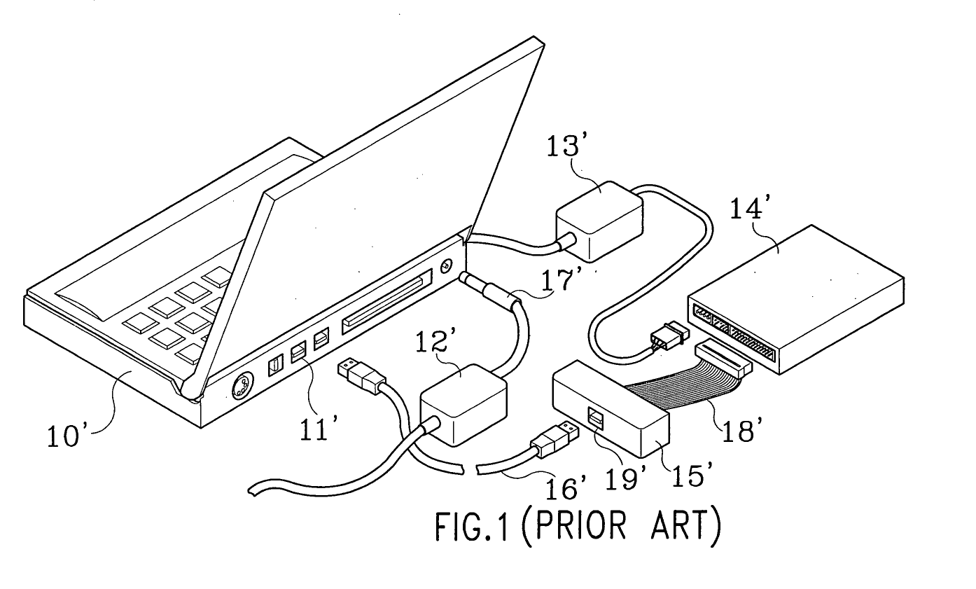

### DETAILED DESCRIPTION OF THE PREFERRED EMBODIMENT

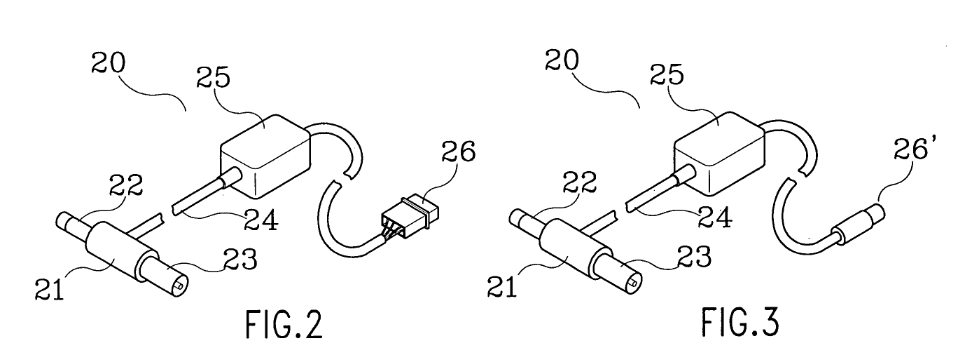

Referring to FIGS. 2 and 3, a notebook DC power sharing arrangement 20 is shown comprising an adapter 21, which has an electric plug 22 at one end for DC power output and an electric socket 23 at the other end for DC power input, a DC power converter 25 for converting input power to a predetermined voltage level of DC power supply, a cable 24 connected between the adapter 21 and the DC power converter 25 for transmission of power supply from the adapter 21 to the DC power converter 25, and a power cable 26 or 26′ extended from the DC power converter 25 for power output. The power cable 26 of the embodiment shown in FIG. 2 and the power cable 26′ of the embodiment shown in FIG. 3 fit different power jacks of different computer peripheral apparatus (Hard Disk Drive, CD-ROM Player, DVD-ROM Player, Digital Camera, Hub, etc.).

The aforesaid DC power converter 25 is adapted to convert input power from the adapter 21 into a particular voltage level for a particular peripheral apparatus (for example, DC 3.3V for digital camera, DC 5V for Hub, or DC 12V for Hard Disk Drive/CD-ROM Player/DVD-ROM Player).

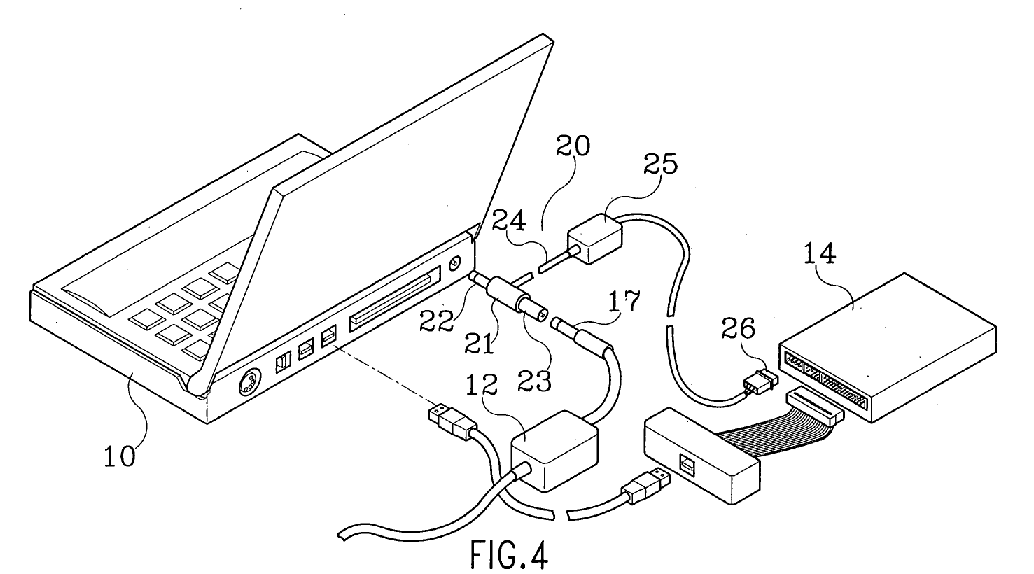

FIG. 4 shows an application example of the present invention. As illustrated, the electric socket 23 of the adapter 21 is connected to the power output plug 17 of an external DC power supply device 12 for power input; the electric plug 22 of the adapter 21 is connected to the power jack of a notebook computer 10 for transmitting DC power supply from the DC power supply device 12 to the notebook computer 10; the power cable 26 is connected to the power jack of a peripheral apparatus 14 for transmitting outputted DC power supply from the DC power converter 25 to the peripheral apparatus 14.

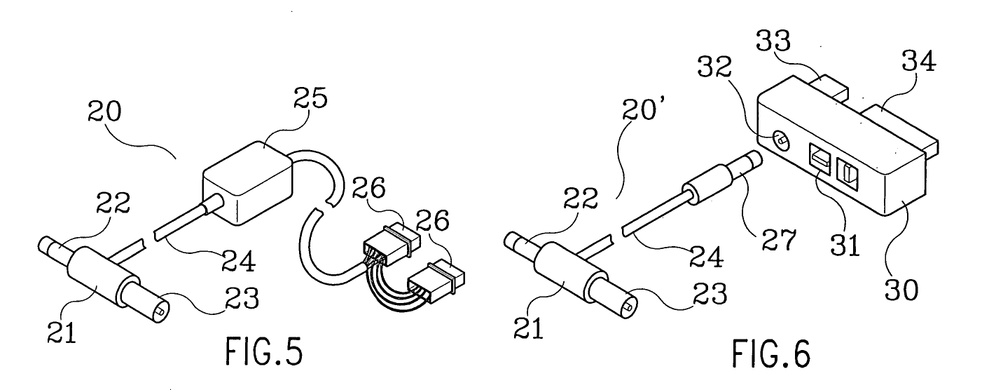

FIG. 5 shows another alternate form of the present invention. According to this embodiment, two power cables 26 are connected in parallel to the DC power converter 25 for power output to different peripheral apparatus that consume same DC voltage.

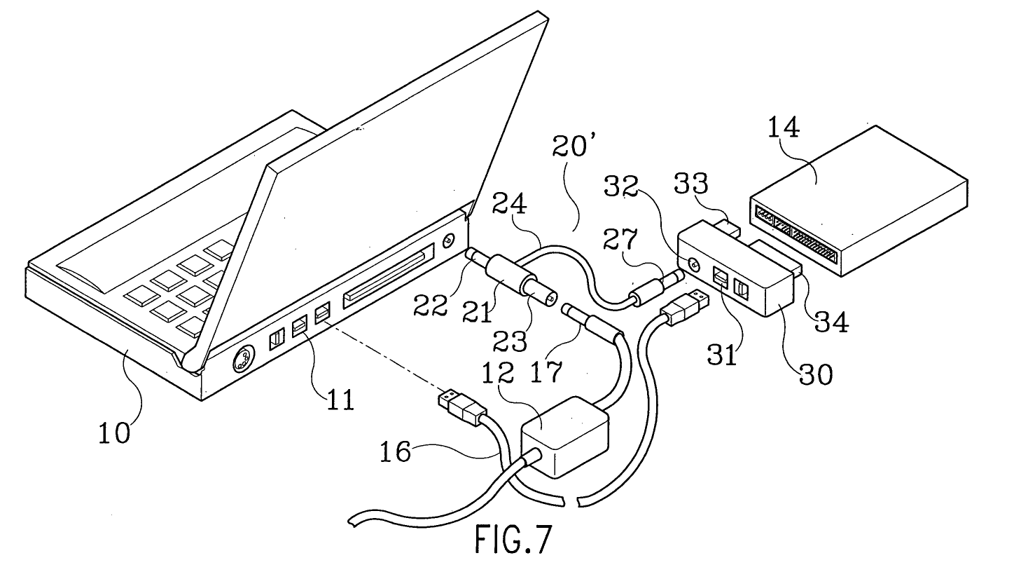

FIGS. 6 and 7 show still another alternate form of the present invention. According to this embodiment, the notebook DC power sharing arrangement 20′ comprises an adapter 21, which has an electric socket 23 at one end for receiving DC power from the power output plug 17 of an external DC power supply device 12 and an electric plug 22 at the other end for connection of the power jack of a notebook computer 10 to transmit DC power supply from the external DC power supply device 12 to the notebook computer 10, a cable 24 extended from the adapter 21 and terminated in an electric plug 27 for connection to the power jack 32 of an electric connecting device 30, which comprises a signal input port (USB port or IEEE1394 port) 31 for receiving signal from one USB port 11 of the notebook computer 10 through a USB cable 16, an internal power converter circuit adapted to convert input DC power to a predetermined voltage level, an electric plug 33 for connection to the power jack of a peripheral apparatus 14 to transmit output DC power supply from the internal power converter circuit to the peripheral apparatus 14, and an electric connector 34 for connection to a signal input connector of the peripheral apparatus 14 for transmission of data between the peripheral apparatus 14 and the notebook computer 10.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A notebook DC power sharing arrangement comprising:
an adapter, said adapter having an electric socket at a first end thereof for DC input from an external DC power supply device and an electric plug at a second end thereof for connection to the power jack of a notebook computer for transmitting DC power supply from said electric socket into said notebook computer;
a DC power converter adapted to convert DC power obtained from said electric socket of said adapter into a predetermined voltage level;
a cable connected between said adapter and said DC power converter for transmission of DC power from said electric socket of said adapter to said DC power converter; and
at least one power cable extended from said DC power converter for power output.
